(19) United States
(12) Patent Application Publication
(10) Pub. No.: US 2016/0160014 A1
(43) Pub. Date: Jun. 9, 2016

(54) SULFUR-CROSSLINKABLE RUBBER MIXTURE

(71) Applicant: Continental Reifen Deutschland GmbH, Hannover (DE)

(72) Inventors: Kirsten Schwekendiek, Bensheim (DE); Carla Recker, Hannover (DE); Norbert Mueller, Nienhagen (DE)

(21) Appl. No.: 15/046,020

(22) Filed: Feb. 17, 2016

Related U.S. Application Data
(63) Continuation of application No. PCT/EP2014/063224, filed on Jun. 24, 2014.

(30) Foreign Application Priority Data
Aug. 19, 2013 (DE) 10 2013 108 937.2

(51) Int. Cl. C08L 9/00

(52) U.S. Cl. CPC C08L 9/00; C08L 2205/02; C08L 2205/03; C08L 2205/06; C08L 2312/00

(57) ABSTRACT

A sulfur-crosslinkable rubber mixture for pneumatic tires is disclosed. The rubber mixture includes at least one diene rubber and 10 to 200 phr of at least one silica and 2 to 20 phf of at least one silane having the general empirical formula (I) [(R¹)₃Si—X]ₘSₙ(R²)₂₋ₘ. The R¹ radicals within a molecule may be the same or different and are alkoxy groups having 1 to 10 carbon atoms or cyclic dialkoxy groups having 2 to 10 carbon atoms or cycloalkoxy groups having 4 to 10 carbon atoms or phenoxy groups or halides, and where m assumes the value of 1 or 2 and where n is an integer from 1 to 8 and where R² is a hydrogen atom or an acyl group having 1 to 20 carbon atoms and where X is an organic spacer group having 3 to 30 carbon atoms and containing at least one organic radical. The organic radical is a) an allyl group; b) a phenyl group which has linkages to the silicon atom of the silyl group (R¹)₃Si— and to a sulfur atom of the Sₙ group via an alkyl radical having 0 to 20 carbon atoms in the 1,2 positions relative to one another; c) a phenyl group which has linkages to the silicon atom of the silyl group (R¹)₃Si— and to a sulfur atom of the Sₙ group via an alkyl radical having 0 to 20 carbon atoms in the 1,3 positions relative to one another; d) a phenyl group which has linkages to the silicon atom of the silyl group (R¹)₃Si— and to a sulfur atom of the Sₙ group via an alkyl radical having 0 to 20 carbon atoms in the 1,4 positions relative to one another; or e) fused aromatic ring systems which have linkages to the silicon atom of the silyl group (R¹)₃Si— and to a sulfur atom of the Sₙ group via an alkyl radical having 0 to 20 carbon atoms.

### CROSS REFERENCE TO RELATED APPLICATIONS

This application is a continuation application of international patent application PCT/EP2014/063224, filed Jun. 24, 2014, designating the United States and claiming priority from German application 10 2013 108 937.2, filed Aug. 19, 2013, and the entire content of both applications is incorporated herein by reference.

### FIELD OF THE INVENTION

The invention relates to a sulfur-crosslinkable rubber mixture, especially for treads of pneumatic vehicle tires, and to a vehicle tire.

### BACKGROUND OF THE INVENTION

The rubber composition of the tread goes a long way to determining the driving properties of a vehicle tire, especially of a pneumatic vehicle tire. The term “vehicle tire” in the present specification refers to pneumatic vehicle tires, solid rubber tires, and bicycle tires.

Similarly, the rubber mixtures which are used especially in the highly mechanically loaded areas of drive belts, hoses, and other belts are responsible substantially for stability and long life of these rubber articles. Consequently, these rubber mixtures for pneumatic vehicle tires, drive belts, other belts, and hoses are subject to very stringent requirements.

Conflicts of objective exist between the majority of the known tire properties such as wet grip, dry braking, handling behavior, rolling resistance, winter properties, abrasion characteristics, and tear properties.

In the context of pneumatic vehicle tires in particular, diverse efforts have been made to exert a positive influence on the properties of the tire by varying the polymer components, the fillers, and the other adjuvants, particularly in the tread mixture.

In this context it must be borne in mind that an improvement in one property of the tire often brings with it a deterioration in another property.

Within a given mixture system, for example, there are different known possibilities for optimizing handling by increasing the stiffness of the rubber mixture. Examples that may be mentioned here include increasing the degree of filling and increasing the network node density of the vulcanized rubber mixture. While an increased filler fraction entails disadvantages in the rolling resistance, the lifting of the network results in a deterioration in the tear properties and also in the wet grip indicators of the rubber mixture.

It is known, moreover, that rubber mixtures, in particular for the tread of pneumatic vehicle tires, may include silica as a filler. It is also known that advantages arise in terms of the rolling resistance behavior and the ease of processing of the rubber mixture if the silica is attached to the polymer or polymers by means of silane coupling agents.

Silane coupling agents known in the prior art are evident from U.S. Pat. No. 4,229,333 and from DE 2255577 C3, for example.

### SUMMARY OF THE INVENTION

It is an object of the present invention, then, to provide a rubber mixture which in comparison to the prior art exhibits a greater stiffness and at the same time offers a further improvement in the tradeoff between rolling resistance and wet grip. At the same time there ought to be no disadvantageous effect on the ease of processing of the rubber mixture.

This object is achieved by means of a rubber mixture which comprises the following constituents:
at least one diene rubber and
10 to 200 phr of at least one silica and
2 to 20 phf of at least one silane having the general empirical formula

[(R¹)₃Si—X]ₘSₙ(R²)₂₋ₘ, I)
where the radicals R¹ may be identical or different within one molecule and are alkoxy groups having 1 to 10 carbon atoms or cyclic dialkoxy groups having 2 to 10 carbon atoms or cycloalkoxy groups having 4 to 10 carbon atoms or phenoxy groups or halides, and where m takes on a value of 1 or 2, and where n is an integer from 1 to 8, and where R² is a hydrogen atom or an acyl group having 1 to 20 carbon atoms, and where X is an organic spacer group having 3 to 30 carbon atoms that comprises at least one organic radical selected from the group consisting of:
a) at least one allyl group and
b) at least one phenyl group which has linkages to the silicon atom of the silyl group (R¹)₃Si— and also to a sulfur atom of the Sₙ group, via an alkyl radical having 0 to 20 carbon atoms, that are arranged in 1,2-position to one another, and which may carry further substituents, and
c) at least one phenyl group which has linkages to the silicon atom of the silyl group (R¹)₃Si— and also to a sulfur atom of the Sₙ group, via an alkyl radical having 0 to 20 carbon atoms, that are arranged in 1,3-position to one another, and which may carry further substituents, and
d) at least one phenyl group which has linkages to the silicon atom of the silyl group (R¹)₃Si— and also to a sulfur atom of the Sₙ group, via an alkyl radical having 0 to 20 carbon atoms, that are arranged in 1,4-position to one another, and which additionally carries at least one further substituent, and
e) fused aromatic ring systems, which have linkages to the silicon atom of the silyl group (R¹)₃Si— and also to a sulfur atom of the Sₙ group that are arranged via an alkyl radical having 0 to 20 carbon atoms, and which may additionally carry at least one further substituent.

Surprisingly, as a result of the combination of the constituents identified above, in comparison to the prior art, the rubber mixture exhibits a greater stiffness while having improved indicators for the tradeoff between rolling resistance and wet grip. At the same time, surprisingly, the rubber mixture exhibits optimized ease of processing. Pneumatic vehicle tires which comprise the rubber mixture of the invention in the tread and/or in other components show optimized behavior in relation to the conflicting objects of handling, rolling resistance, and wet grip, while being easier to produce.

The phr (parts per hundred parts of rubber by weight) figure used in this specification is the customary quantitative figure for mixture formulas in the rubber industry. The addition of the parts by weight of the individual substances is based in this specification on 100 parts by weight of the overall composition of all of the high molecular mass, and therefore solid, rubbers that are present in the mixture.

The phf figure (parts per hundred parts of filler by weight) used in this specification is the quantitative figure commonplace within the rubber industry for coupling agents for fillers.

For the purposes of the present specification, phf is based on the silica present, meaning that any other fillers present, such as carbon black, are not included in the calculation of the amount of silane.

In accordance with the invention, the rubber mixture comprises at least one diene rubber. Diene rubbers is the term for rubbers which form by polymerization or copolymerization of dienes and/or cycloalkenes and therefore have C═C double bonds either in the main chain or in the side groups. The diene rubber here is selected from the group consisting of natural polyisoprene and/or synthetic polyisoprene and/or epoxidized polyisoprene and/or butadiene rubber and/or solution-polymerized styrene-butadiene rubber and/or emulsion-polymerized styrene-butadiene rubber and/or halobutyl rubber and/or polynorbornene and/or isoprene-isobutylene copolymer and/or ethylene-propylene-diene rubber and/or nitrile rubber and/or acrylate rubber and/or fluoro rubber and/or chloroprene rubber and/or silicone rubber and/or polysulfide rubber and/or epichlorohydrin rubber and/or styrene-isoprene-butadiene terpolymer and/or hydrogenated acrylonitrile-butadiene rubber and/or isoprene-butadiene copolymer and/or hydrogenated styrene-butadiene rubber.

The diene rubber is preferably selected from the group consisting of natural polyisoprene and/or synthetic polyisoprene and/or butadiene rubber and/or solution-polymerized styrene-butadiene rubber and/or emulsion-polymerized styrene-butadiene rubber.

According to a preferred development of the invention there is at least one styrene-butadiene rubber in the rubber mixture. The combination of at least one styrene-butadiene rubber with at least one abovementioned silane having an organic spacer group X in the above configuration produces particularly high stiffnesses in conjunction with improved tradeoff between rolling resistance behavior versus wet grip properties. This preferred development therefore resolves the tradeoff between rolling resistance, wet grip, and handling at a particularly high level, in conjunction with improved ease of processing.

The amount of styrene-butadiene rubber is preferably 1 to 95 phr, more preferably 10 to 95 phr, very preferably 10 to 50 phr. Especially preferably in turn, to 50 phr of styrene-butadiene rubber are used in the rubber mixture of the invention.

The styrene-butadiene rubber is more preferably a solution-polymerized styrene-butadiene rubber. In this case the stated advantages of the invention (increased stiffness, improvement in terms of the tradeoff between rolling resistance and wet grip, improved ease of processing) arise in conjunction with very good physical properties otherwise, especially tensile strength, tear properties, and abrasion behavior, on the part of the rubber mixture.

According to a further preferred development of the invention, at least two different types of diene rubber are used in the rubber mixture. In this case it is preferred for there to be at least one styrene-butadiene rubber and at least one natural and/or synthetic polyisoprene and/or at least one butadiene rubber in the rubber mixture. This results in particularly high ease of processing and in an improvement in the rubber mixture in terms of the physical properties, particularly the indicators for rolling resistance and wet grip.

The amount of styrene-butadiene rubber is preferably 1 to 95 phr, more preferably 10 to 95 phr, very preferably 10 to 50 phr. Especially preferably in turn, to 50 phr of styrene-butadiene rubber are used in the rubber mixture of the invention. The amount of natural and/or synthetic polyisoprene in this case is preferably 0.1 to 100 phr, preferably 0.1 to 50 phr, and very preferably 10 to 30 phr. The amount of butadiene rubber is preferably 0.1 to 80 phr, more preferably 0.1 to 60 phr, and very preferably 20 to 60 phr.

According to a further preferred development of the invention, three different types of diene rubber are used in the rubber mixture. In this case there is preferably at least one styrene-butadiene rubber and one natural polyisoprene and one butadiene rubber in the rubber mixture. This results in particularly high ease of processing and in an improvement in the rubber mixture in terms of the physical properties, especially the indicators for rolling resistance and wet grip.

The rubber mixture of the invention contains 20 to 150 phr, preferably 40 to 150 phr, more preferably 40 to 110 phr, and very preferably 80 to 110 phr of at least one silica.

The silicas may be the silicas which are known to the skilled person and are suitable as filler for tire rubber mixtures. Particularly preferred, however, is the use of a finely divided, precipitated silica which has a nitrogen surface area (BET surface area) (in accordance with DIN ISO 9277 and DIN 66132) of 80 to 350 m²/g, preferably of 80 to 250 m²/g, more preferably 110 to 235 m²/g, and a CTAB surface area (according to ASTM D 3765) of 80 to 350 m²/g, preferably of 80 to 245 m²/g, more preferably of 110 to 205 m²/g. In rubber mixtures for tire treads, for example, silicas of this kind lead to particularly good physical properties on the part of the vulcanizates. Moreover, they may result in advantages in mixture processing, by reducing the mixing time while other product properties are unchanged, leading to improved productivity. Silicas employed accordingly may be, for example, those of the Ultrasil® VN3 (trade name) type from Evonik, and also highly dispersible silicas, termed HD silicas (for example, Zeosil® 1165 MP from Rhodia).

In a preferred embodiment, the rubber mixture comprises at least one silane which has the general empirical formula

[(R¹)₃Si—X]ₘSₙ(R²)₂₋ₘ, I)
where the radicals R¹ may be identical or different within one molecule and are alkoxy groups having 1 to 10 carbon atoms or cyclic dialkoxy groups having 2 to 10 carbon atoms or cycloalkoxy groups having 4 to 10 carbon atoms or phenoxy groups or halides, and where m takes on a value of 1 or 2, and where n is an integer from 1 to 8, and where R² is a hydrogen atom or an acyl group having 1 to 20 carbon atoms, and where X is an organic spacer group having 3 to 30 carbon atoms that comprises at least one organic radical selected from the group consisting of:
a) at least one allyl group and
b) at least one phenyl group which has linkages to the silicon atom of the silyl group (R¹)₃Si— and also to a sulfur atom of the Sₙ group, via an alkyl radical having 0 to 20 carbon atoms, that are arranged in 1,2-position to one another, and which may carry further substituents, and
c) at least one phenyl group which has linkages to the silicon atom of the silyl group (R¹)₃Si— and also to a sulfur atom of the Sₙ group, via an alkyl radical having 0 to 20 carbon atoms, that are arranged in 1,3-position to one another, and which may carry further substituents, and
d) at least one phenyl group which has linkages to the silicon atom of the silyl group (R¹)₃Si— and also to a sulfur atom of the Sₙ group, via an alkyl radical having 0 to 20 carbon atoms, that are arranged in 1,4-position to one another, and which additionally carries at least one further substituent,
and
e) fused aromatic ring systems, which have linkages to the silicon atom of the silyl group (R¹)₃Si— and also to a sulfur atom of the Sₙ group that are arranged via an alkyl radical having 0 to 20 carbon atoms, and which may additionally carry at least one further substituent.

This silane acts as a coupling agent to attach the silica present in the rubber mixture to the polymer chains of the diene rubber or diene rubbers.

Silane coupling agents are common knowledge and react with the surface silanol groups of the silica or with other polar groups during the mixing of the rubber or the rubber mixture (in situ) or even before the addition of the filler to the rubber, in the manner of a pretreatment (preliminary modification).

In a preferred embodiment, the aforementioned silane is a total or partial replacement for the prior-art silanes such as TESPD (3,3′-bis(triethoxysilylpropyl)disulfide) or TESPT (3,3′-bis(triethoxysilylpropyl) tetrasulfide), with a simultaneous increase in stiffness, without any disadvantages in terms of rolling resistance and wet grip behaviors becoming apparent.

With preference there is a mole-equivalent replacement of the prior-art silane or silanes by the abovementioned silane with at least one organic spacer group as set out above. Mole-equivalent replacement means, for the purposes of the present invention, that the abovementioned silane is employed in quantities such that the same molar amount of silyl groups is available for the attachment to the silica as using prior-art quantities of the prior-art silanes.

In the context of the present invention it is also conceivable for the abovementioned silane having the general empirical formula I) to be used in combination with silanes from the prior art.

A silyl group in the context of the present invention refers to the moiety (R¹)₃Si—.

The silane having the general empirical formula I) is present in amounts of 2 to 20 phf, preferably 2 to 15 phf, more preferably 5 to 15 phf in the rubber mixture of the invention.

It is essential to the invention that the silane having the above-stated empirical formula has an organic spacer group X having 3 to 30 carbon atoms that comprises at least one organic radical selected from the group consisting of:
a) at least one allyl group and
b) at least one phenyl group which has linkages to the silicon atom of the silyl group (R¹)₃Si— and also to a sulfur atom of the Sₙ group, via an alkyl radical having 0 to 20 carbon atoms, that are arranged in 1,2-position to one another, and which may carry further substituents, and
c) at least one phenyl group which has linkages to the silicon atom of the silyl group (R¹)₃Si— and also to a sulfur atom of the Sₙ group, via an alkyl radical having 0 to 20 carbon atoms, that are arranged in 1,3-position to one another, and which may carry further substituents, and
d) at least one phenyl group which has linkages to the silicon atom of the silyl group (R¹)₃Si— and also to a sulfur atom of the Sₙ group, via an alkyl radical having 0 to 20 carbon atoms, that are arranged in 1,4-position to one another, and which additionally carries at least one further substituent,
and
e) fused aromatic ring systems, which have linkages to the silicon atom of the silyl group (R¹)₃Si— and also to a sulfur atom of the Sₙ group that are arranged via an alkyl radical having 0 to 20 carbon atoms, and which may additionally carry at least one further substituent.

This therefore organic arylic and/or organic allylic group X links the silicon atom or atoms to a sulfur atom of the moiety Sₙ. Where there are two or more organic radicals in the organic spacer group X, these may be identical to or different from one another.

Organic spacer group X is also called a linking spacer group because it determines the spacing between silicon (attachment to the filler) and sulfur (attachment to the diene rubber).

The organic spacers known in the prior art have alkyl groups, with a propyl radical (or else called a propyl group) being customary, as in the above-recited silanes TESPD and TESPT.

With the rubber mixture of the invention it has been found that using a silane having an organic arylic and/or an organic allylic spacer group X rather than a silane having a purely alkylic spacer, an increased stiffness of the rubber mixture is achieved in conjunction with a shortening of the time for full vulcanization.

Moreover, particularly good properties of the rubber mixture arise in respect of the tradeoff between rolling resistance behavior, wet grip properties, and handling behavior, if at least one styrene-butadiene rubber is present at the same time.

Aryl groups are known generally in chemistry and especially in the rubber chemistry art. According to Römpp Online, Version 3.29, “Aryl . . . ” is a general designation for aromatic (hydrocarbon) radicals. It may refer, for example, to phenyl (C₆H₅—), naphthyl (C₁₀H₇—) or anthryl (C₁₄H₉—) radicals and/or to derivatives of these moieties. Preferred derivatives of the stated aryl groups are those which carry an alkyl group on the aromatic scaffold in place of one or more hydrogen atoms.

The above listing includes organic spacer groups having 3 to 30 carbon atoms which comprise aryl groups as per options b), c), d), or e), which are elucidated in more detail below:

According to embodiment b), the organic spacer group X comprises as organic radical at least one phenyl group which has linkages to the silicon atom of the silyl group (R¹)₃Si— and also to a sulfur atom of the Sₙ group, via an alkyl radical having 0 to 20 carbon atoms, that are arranged in 1,2-position to one another, and which may carry further substituents.

This embodiment therefore embraces not only the direct attachment of the silicon atom and/or of the sulfur atom to the aromatic scaffold, but also the attachment of the silicon atom and/or of the sulfur atom to the aromatic scaffold via alkyl groups having 1 to 20 carbon atoms.

These alkyl groups disposed between the silicon atom and the aromatic scaffold or between the sulfur atom and the aromatic scaffold may be branched or unbranched.

Furthermore, according to embodiment b), there may be further substituents attached to the aromatic scaffold in addition to the linkages to the silicon atom and to the sulfur atom. The further substituents may be, for example, alkyl radicals having 1 to 10 carbon atoms. The further substituent preferably comprises an alkyl group having 1 to 3 carbon atoms, more preferably a methyl group having one carbon atom.

The aromatic scaffold according to embodiment b) is a phenyl ring. Accordingly, the linkages to the silicon atom of the silyl group (R¹)₃Si— and also to a sulfur atom of the Sₙ group are in ortho-position to one another.

In this case, in position 3 and/or 4 and/or 5 and/or 6, there may then be further substituents, preferably an alkyl group having 1 to 10 carbon atoms, more preferably a methyl group having one carbon atom, attached to the phenyl ring.

According to embodiment c), the organic spacer group X comprises as organic radical at least one phenyl group which has linkages to the silicon atom of the silyl group (R¹)₃Si— and also to a sulfur atom of the Sₙ group, via an alkyl radical having 0 to 20 carbon atoms, that are arranged in 1,3-position to one another, and which may carry further substituents.

This embodiment therefore embraces not only the direct attachment of the silicon atom and/or of the sulfur atom to the aromatic scaffold, but also the attachment of the silicon atom and/or of the sulfur atom to the aromatic scaffold via alkyl groups having 1 to 20 carbon atoms.

These alkyl groups disposed between the silicon atom and the aromatic scaffold or between the sulfur atom and the aromatic scaffold may be branched or unbranched.

Furthermore, according to embodiment c), there may be further substituents attached to the aromatic scaffold in addition to the linkages to the silicon atom and to the sulfur atom. The further substituents may be, for example, alkyl radicals having 1 to 10 carbon atoms. The further substituent preferably comprises an alkyl group having 1 to 3 carbon atoms, more preferably a methyl group having one carbon atom.

The aromatic scaffold according to embodiment c) is a phenyl ring. Accordingly, the linkages to the silicon atom of the silyl group (R¹)₃Si— and also to a sulfur atom of the Sₙ group are in meta-position to one another. In this case, in position 2 and/or 4 and/or 5 and/or 6, there may then be further substituents, preferably an alkyl group having 1 to 10 carbon atoms, more preferably a methyl group having one carbon atom, attached to the phenyl ring.

According to embodiment d), the organic spacer group X comprises as organic radical at least one phenyl group which has linkages to the silicon atom of the silyl group (R¹)₃Si— and also to a sulfur atom of the Sₙ group, via an alkyl radical having 0 to 20 carbon atoms, that are arranged in 1,4-position to one another, and which additionally carries at least one further substituent.

This embodiment therefore embraces not only the direct attachment of the silicon atom and/or of the sulfur atom to the aromatic scaffold, but also the attachment of the silicon atom and/or of the sulfur atom to the aromatic scaffold via alkyl groups having 1 to 20 carbon atoms.

These alkyl groups disposed between the silicon atom and the aromatic scaffold or between the sulfur atom and the aromatic scaffold may be branched or unbranched.

Furthermore, according to embodiment d), there may be further substituents attached to the aromatic scaffold in addition to the linkages to the silicon atom and to the sulfur atom. The further substituents may be, for example, alkyl radicals having 1 to 10 carbon atoms. The further substituent preferably comprises an alkyl group having 1 to 3 carbon atoms, more preferably a methyl group having one carbon atom.

The aromatic scaffold according to embodiment d) is a phenyl ring. Accordingly, the linkages to the silicon atom of the silyl group (R¹)₃Si— and also to a sulfur atom of the Sₙ group are in para-position to one another. In this case, in position 2 and/or 3 and/or 5 and/or 6, there may then be further substituents, preferably an alkyl group having 1 to 10 carbon atoms, more preferably a methyl group having one carbon atom, attached to the phenyl ring.

According to embodiment e), the organic spacer group X comprises as organic radical at least one fused aromatic ring system, which has linkages to the silicon atom of the silyl group (R′)₃Si— and also to a sulfur atom of the Sₙ group that are arranged via an unbranched alkyl radical having 0 to 20 carbon atoms, and which may additionally carry at least one further substituent.

“Fused ring systems” are understood according to RÖMPP Online Lexikon, Version 3.34, to be “those ring systems” . . . “in which benzene rings are fused with one another, that is, joined ringwise to one another by condensation”. Fused aromatic ring systems are, consequently, fused ring systems which are aromatic. This includes the naphthalene and anthracene systems already disclosed above as aryl groups.

According to embodiment e), both the direct attachment of the silicon atom and/or of the sulfur atom to the aromatic scaffold, and the attachment of the silicon atom and/or the sulfur atom via alkyl groups having 1 to 20 carbon atoms to the aromatic scaffold are encompassed. These alkyl groups disposed between the silicon atom and the aromatic scaffold or between the sulfur atom and the aromatic scaffold may be branched or unbranched.

The linkages between the silicon atom and the aromatic scaffold and between the sulfur atom and the aromatic scaffold, respectively, may be arranged here in all positions known to the skilled person. Taking the example of a naphthyl group, for example, this means that the sulfur atom may be attached at position 1, and the silicon atom of the silyl group may be attached at position 2 or at position 8, resulting formally in a 1,2 or 1,8 substitution of naphthalene, respectively.

Where the fused aromatic ring system is the derivative of phenanthrene whose respective linkages to the silicon atom of the silyl group (R¹)₃Si— and also to a sulfur atom of the Sₙ group are in the 2,7-position to one another, the alkylic linkages contain no heteroatoms and/or there are further substituents attached on the phenanthrene scaffold.

Allyl groups are common knowledge in chemistry and are known especially in the rubber chemistry art. According to Römpp Online, Version 3.29, “Allyl . . . ” is a term for the atomic grouping —CH₂—CH═CH₂.

According to embodiment a), the organic spacer group X comprises at least one allyl group. The attachment to the sulfur atom of the moiety Sₙ and also to the silicon atom of the silyl group (R¹)₃Si— may be direct or via an unbranched alkyl radical having 1 to 20 carbon atoms.

“Unbranched alkyl radical” for the purposes of the present invention refers to a carbon chain which has no carbon atom having three single bonds to other carbon atoms, and which therefore contains no cycloalkane radical.

The result of using a silane having an organic spacer group which is selected from options a) and b) and c) and d) and e), in comparison to purely alkylic spacers, that is, spacers which are only alkyl groups, is an improved interaction with diene rubbers, especially with styrene-butadiene rubbers.

In one particularly preferred embodiment, the organic spacer group X is configured as per b) or c) or d) or e) and is therefore an arylic spacer. With very particular preference, a silane in embodiment c) of the organic spacer group is used in the rubber mixture of the invention. Achieved hereby are particularly high stiffnesses in conjunction with improved tradeoff of the indicators for rolling resistance and wet grip on the part of the rubber mixture.

The radical R¹ bonded to the silicon atom are alkoxy groups having 1 to 10 carbon atoms or cyclic dialkoxy groups having 2 to 10 carbon atoms or cycloalkoxy groups having 4 to 10 carbon atoms or phenoxy groups or halides, and may be identical to or different from one another within one molecule. It is also conceivable here for the cyclic dialkoxy group to be attached in such a way that it is bonded to the silicon atom with both oxygen atoms and hence counts as two attached radicals R¹, with the other radical R¹ being selected from the options stated above.

Preferably, however, R¹ comprises methoxy and/or ethoxy groups. With particular preference, all three radicals R¹ are identical and are methoxy and/or ethoxy groups, and very preferably are three ethoxy groups.

The index m may take on the values 1 or 2. The group II) [(R¹)₃Si—X] may therefore be present once or twice per molecule. In the case of m=2, therefore, the sulfur is bonded only to two of these groups, and so in this case there is no radical R² in the molecule. The two groups II) are then linked via the moiety Sₙ where n=1 to 8, in other words via a sulfur atom or a chain of 2 to 8 sulfur atoms. Preferably n is an integer from 2 to 6, more preferably from 2 to 4. This produces particularly good properties in respect of the stiffness and the vulcanization behavior, especially the time for full vulcanization.

Where m=1, a radical R² is bonded to the sulfur atom furthest from the silyl group. R² is a hydrogen atom or an acyl group having 1 to 20 carbon atoms. Where the radical R² is an acyl group, the carbon atom which carries the keto group, in other words the double bond to the oxygen atom, is preferably bonded to the sulfur atom furthest from the silyl group.

A silyl group for the purposes of the present invention refers to the moiety

(R¹)₃Si—. III)

Accordingly, the silane may be either a mercaptosilane or a protected mercaptosilane, also called blocked mercaptosilane.

The rubber mixture of the invention preferably comprises a silane having the structure below:

[(R¹)₃Si—X]₂Sₙ IV)

in the empirical formula I) specified above, therefore, m is 2, and so the moiety Sₙ is linked at both sides to a moiety

[(R¹)₃Si—X]. II)

With particular preference the organic spacer groups X and the radicals R¹ are identical on both sides of the molecule.

In that case R¹ is more preferably an ethoxy group, which is then present a total of six times in the molecule.

Preferably X on both sides is an organic spacer group as per embodiment b) or c) or d). With particular preference the aromatic molecular moiety here, in other words the phenyl ring, is bonded to the silicon atom via an alkyl group, and so the organic spacer group is the derivative of an aromatic compound having at least one alkyl group as substituent.

It is particularly preferred if the organic spacer group X is a derivative of 1-ethyl-3-methylbenzene. In this case the ethyl group is the link between the silicon atom of the silyl group and the aromatic scaffold, and the methyl group is a further substituent in position 3, in other words in “meta-position” to the ethyl radical. The attachment to a sulfur atom of the Sₙ group is in position 5, and so the phenyl ring is 1,3,5-substituted.

In this case the sulfur atom on each side is preferably bonded directly to the aromatic scaffold of the derivative of an aryl group.

The preferred silane has the following structure:

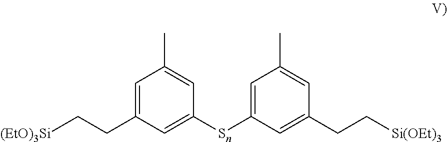

With this silane, with n=2 to 4, particularly good stiffnesses are achieved in conjunction with improved tradeoff between rolling resistance and wet grip, and improved ease of processing.

Preferably, in the general empirical formula I), n is 2 to 4, and so there is a chain of two to four sulfur atoms, with one sulfur atom bonded to each of the organic spacer groups.

Besides silica, the rubber mixture of the invention may comprise other known polar and/or nonpolar fillers, such as carbon black, for example.

Where the rubber mixture of the invention includes carbon black, the carbon black used preferably has an iodine adsorption number to ASTM D 1510 of 60 to 200 g/kg, preferably 70 to 200 g/kg, more preferably 70 to 150 kg/g, and a DBP number to ASTM D 2414 of 80 to 200 ml/100 g, preferably 100 to 200 ml/100 g, more preferably 100 to 150 ml/100 g.

The amount of carbon black in the rubber mixture of the invention is preferably 0 to 50 phr, more preferably 0 to 20 phr, and very preferably 0 to 7 phr, but in one preferred embodiment at least 0.1 phr.

In another preferred embodiment of the invention, the rubber mixture contains 0 to 0.5 phr of carbon black.

In the rubber mixture there may be 0 to 100 phr, preferably 0.1 to 80 phr, more preferably 0.1 to 70 phr, and very preferably 0.1 to 50 phr of at least one plasticizer. This plasticizer is selected from the group consisting of mineral oils and/or synthetic plasticizers and/or fatty acids and/or fatty acid derivatives and/or resins and/or factices and/or glycerides and/or terpenes and/or rubber-to-liquid oils (RTL oils) and/or biomass-to-liquid oils (BTL oils) and/or liquid polymers (such as liquid BR) with an average molecular weight (determined by GPC, that is, gel permeation chromatography, in a method based on BS ISO 11344:2004) of between 500 and 25 000 g/mol. Where liquid polymers are used as plasticizers in the rubber mixture of the invention, they are not included as rubber in the calculation of the polymer matrix composition.

Mineral oils are particularly preferred plasticizers. Where mineral oil is used, it is preferably selected from the group consisting of DAE (Distillate Aromatic Extracts) and/or RAE (Residual Aromatic Extract) and/or TDAE (Treated Distillate Aromatic Extracts) and/or MES (Mild Extracted Solvents) and/or naphthenic oil.

The sulfur-crosslinkable rubber mixture of the invention further comprises a vulcanizing system which comprises at least one accelerator and elemental sulfur and/or a sulfur-donating substance (also called sulfur donor). The amounts of these stated constituents in the vulcanizing system are customary amounts, known in the prior art, in sulfur-crosslinked rubber mixtures.

The accelerator is selected from the group containing, for example, thiazole accelerators and/or mercapto accelerators and/or sulfenamide accelerators and/or thiocarbamate accelerators and/or thiuram accelerators and/or thiophosphate accelerators and/or thiourea accelerators and/or guanidine accelerators and/or xanthogenate accelerators.

Preference is given to the use of at least one sulfenamide accelerator selected from the group consisting of N-cyclohexyl-2-benzothiazolesulfenamide (CBS) and/or N,N-dicyclohexylbenzothiazole-2-sulfenamide (DCBS) and/or benzothiazyl-2-sulfene morpholide (MBS) and/or N-tert-butyl-2-benzothiazylsulfenamide (TBBS).

According to one preferred development of the invention, a plurality of accelerators is present in the rubber mixture.

Particularly preferred is the use of the accelerators TBBS and/or CBS and/or diphenylguanidine (DPG).

Sulfur-donating substances which can be used are all the sulfur-donating substances known to the skilled person. If the rubber mixture includes a sulfur-donating substance, this substance is preferably selected from the group containing, for example, thiuram disulfides, such as tetrabenzylthiuram disulfide (TBzTD) and/or tetramethylthiuram disulfide (TMTD) and/or tetramethylthiuram monosulfide (TMTM) and/or tetraethylthiuram disulfide (TETD), for example, and/or thiuram tetrasulfides, such as dipentamethylenethiuram tetrasulfide (DPTT), for example, and/or dithiophosphates, such as DipDis (bis(diisopropyl)thiophosphoryl disulfide) and/or bis(O,O-2-ethylhexylthiophosphoryl)polysulfide (for example, Rhenocure SDT 50®, Rheinchemie GmbH) and/or zinc dichloryldithiophosphate (for example, Rhenocure ZDT/S®, Rheinchemie GmbH) and/or zinc alkyl dithiophosphate, for example, and/or 1,6-bis(N,N-dibenzylthiocarbamoyldithio)hexane and/or diaryl polysulfides and/or dialkyl polysulfides.

Other network-forming systems too, as available for example under the trade names Vulkuren®, Duralink® or Perkalink®, or network-forming systems, as described in WO 2010/049261 A2, may be used in the rubber mixture.

The rubber mixture of the invention may further comprise customary adjuvants in customary parts by weight. These adjuvants include a) aging inhibitors, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ), for example, b) activators, such as zinc oxide and fatty acids (for example, stearic acid), for example, c) zinc soaps, d) waxes, e) resins, and f) mastication aids, such as 2,2′-dibenzamidodiphenyl disulfide (DBD), for example.

The proportion of the total amount of further adjuvants is 3 to 150 phr, preferably 3 to 100 phr, and more preferably 5 to 80 phr.

Within the overall proportion of the further adjuvants there are, as set out above, 0.1 to 10 phr, preferably 0.2 to 8 phr, more preferably 0.2 to 4 phr of zinc oxide.

It is usual to add zinc oxide as activator, usually in combination with fatty acids (for example, stearic acid), to a rubber mixture for sulfur crosslinking with vulcanization accelerators. The sulfur is then activated for the vulcanization by formation of a complex. The zinc oxide conventionally used has in general in this case a BET surface area of less than 10 m²/g. It is also possible, though, to use so-called nano-zinc oxide, having a BET surface area of 10 to 60 m²/g.

The rubber mixture of the invention is produced by the method customary within the rubber industry, which involves first preparing a base mixture with all of the constituents apart from the vulcanizing system (sulfur and vulcanization-influencing substances) in one or more mixing stages. By addition of the vulcanizing system in a final mixing stage, the completed mixture is produced. The completed mixture is processed further by an extrusion procedure, for example, and brought into the appropriate form.

It is a further object of the present invention to provide a vehicle tire which is distinguished by improved handling characteristics and improved tradeoff between rolling resistance and wet grip properties. This object is achieved by the vehicle tire comprising the rubber mixture of the invention as described above in at least one component. All of the observations made above concerning the constituents and their features are valid here. The component is preferably a tread. As the skilled person is aware, the tread makes a large contribution to the handling characteristics of vehicle tires. With particular preference the vehicle tire is a pneumatic vehicle tire.

The rubber mixture of the invention, however, is also suitable for other components of vehicle tires, such as the sidewall and/or internal components, the so-called body components.

It is a further object of the present invention to improve the handling behavior and the properties with regard to the tradeoff between rolling resistance and wet grip of vehicle tires. This object is achieved in accordance with the invention by the use of the above-described rubber mixture, with all of the abovementioned embodiments and features, in vehicle tires.

The rubber mixture is additionally suitable for producing industrial rubber articles such as, for example, conveyor belts, drive belts, other belts, hoses, printing blankets, air springs, or damping elements.

### DESCRIPTION OF THE PREFERRED EMBODIMENTS OF THE INVENTION

The invention is now to be elucidated in more detail using comparative examples and working examples, which are summarized in Table 1.

The comparative mixtures are labeled C, the inventive mixtures I.

Mixture production took place under customary conditions in three stages in a laboratory tangential mixture. Test specimens were produced from all of the mixtures by optimum vulcanization under pressure at 160° C., and these test specimens were used for determining the physical properties typical for the rubber industry, using the test methods indicated below.
S′min, smallest torque occurring during the vulcanization phase, by rheometer measurement to DIN 53529
Shore A hardness at room temperature (RT) and 70° C. to DIN ISO 7619-1
rebound elasticity at RT and 70° C. to DIN 53512
tensile strength and stress value at 300% static elongation (modulus 300) at room temperature to DIN 53504

TABLE 1

| Constituents | Unit | C1 | I1 | I2 |
|---|---|---|---|---|
| NR TSR | phr | 20 | 20 | 20 |
| BR ^{a)} | phr | 44 | 44 | 44 |
| SSBR ^{b)} | phr | 36 | 36 | 36 |
| Silica ^{c)} | phr | 95 | 95 | 95 |
| Silane ^{d)} | phf | 7.2 | — | — |
| Silane ^{e)} | phf | — | 7.2 | 10.0 |
| Plasticizer | phr | 45 | 45 | 45 |
| Aging inhibitor | phr | 4 | 4 | 4 |
| Stearic acid | phr | 2.5 | 2.5 | 2.5 |
| ZnO | phr | 2.5 | 2.5 | 2.5 |
| Accelerator ^{f)} | phr | 3.6 | 3.6 | 3.6 |
| Sulfur | phr | 2 | 2 | 2 |
| Physical properties | | | | |
| S′ min | dNm | 3 | 2 | 2 |
| Shore hardness at RT | Shore A | 69 | 66 | 68 |
| Shore hardness at 70° C. | Shore A | 63 | 61 | 64 |
| Rebound elasticity at RT | % | 33 | 33 | 34 |
| Rebound elasticity at 70° C. | % | 44 | 44 | 47 |
| Rebound difference (70° C.-RT) | | 11 | 11 | 13 |
| Tensile strength | MPa | 14 | 15 | 14 |
| Modulus 300 | MPa | 6.4 | 6.3 | 7.0 |

Substances used
^{a)} BR: polybutadiene, high-cis Nd-BR, unfunctionalized, Tg = −105° C., BUNA ® CB25, Lanxess
^{b)} SSBR: Sprintane ® SLR-4601, Styron
^{c)} Silica: ULTRASIL ® VN3, Evonik
^{d)} Silane with 75 wt % S2 fraction, Si261 ®, Evonik
^{e)} Silane with organic arylic spacer group of structure V), SIB1820.5, GELEST: 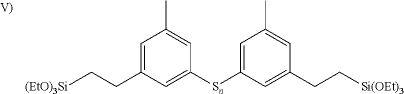
^{f)} Accelerators: DPG (diphenylguanidine) and CBS (N-cyclohexyl-2-benzothiazolesulfenamide)

As evident from Table 1 by comparing I1 and 12 with C1, the inventive rubber mixtures have a greater stiffness, as evident in the increased values for modulus 300. At the same time, the inventive rubber mixture I2, for which there was a mole-equivalent silane replacement relative to C1, exhibits an improvement in the tradeoff between rolling resistance and wet grip, as evident from the indicators of rebound elasticity at 70° C. for rolling resistance and rebound elasticity at room temperature for wet grip, and from the increased difference between the stated rebound elasticities.

At the same time, the inventive rubber mixtures exhibit improved ease of processing, as evident from the reduced values for S′min.

A result of all this, for the use of the rubber mixture of the invention in vehicle tires, especially in treads of pneumatic vehicle tires, is improved handling behavior, improved behavior with regard to the tradeoff between rolling resistance and wet grip, and an improvement in ease of processing of the mixture during the production of the tires.

It is understood that the foregoing description is that of the preferred embodiments of the invention and that various changes and modifications may be made thereto without departing from the spirit and scope of the invention as defined in the appended claims.

What is claimed is:

1. A sulfur-crosslinkable rubber mixture comprising
at least one diene rubber;
10 to 200 phr of at least one silica; and
2 to 20 phf of at least one silane having the general empirical formula
[(R¹)₃Si—X]ₘSₙ(R²)₂₋ₘ, I)
where the radicals R¹ may be identical or different within one molecule and are alkoxy groups having 1 to 10 carbon atoms or cyclic dialkoxy groups having 2 to 10 carbon atoms or cycloalkoxy groups having 4 to 10 carbon atoms or phenoxy groups or halides, and where m takes on a value of 1 or 2, and where n is an integer from 1 to 8, and where R² is a hydrogen atom or an acyl group having 1 to 20 carbon atoms, and where X is an organic spacer group having 3 to 30 carbon atoms that comprises at least one organic radical selected from the group consisting of:
a) at least one allyl group;
b) at least one phenyl group which has linkages to the silicon atom of the silyl group (R¹)₃Si— and also to a sulfur atom of the Sₙ group, via an alkyl radical having 0 to 20 carbon atoms, that are arranged in 1,2-position to one another, and which may carry further substituents;
c) at least one phenyl group which has linkages to the silicon atom of the silyl group (R¹)₃Si— and also to a sulfur atom of the Sₙ group, via an alkyl radical having 0 to 20 carbon atoms, that are arranged in 1,3-position to one another, and which may carry further substituents;
d) at least one phenyl group which has linkages to the silicon atom of the silyl group (R¹)₃Si— and also to a sulfur atom of the Sₙ group, via an alkyl radical having 0 to 20 carbon atoms, that are arranged in 1,4-position to one another, and which additionally carries at least one further substituent;
and,
e) fused aromatic ring systems, which have linkages to the silicon atom of the silyl group (R¹)₃Si— and also to a sulfur atom of the Sₙ group that are arranged via an alkyl radical having 0 to 20 carbon atoms, and which may additionally carry at least one further substituent.

2. The sulfur-crosslinkable rubber mixture as claimed in claim 1, wherein the organic spacer group X is a derivative of 1-ethyl-3-methylbenzene.

3. The sulfur-crosslinkable rubber mixture as claimed in claim 1, wherein the at least one diene rubber is a styrene-butadiene rubber.

4. The sulfur-crosslinkable rubber mixture as claimed in claim 3, wherein the styrene-butadiene rubber is solution-polymerized styrene-butadiene rubber.

5. A vehicle tire comprising a sulfur-crosslinkable rubber mixture as claimed in claim 1 in at least one component.

6. The vehicle tire as claimed in claim 5, wherein the at least one component is a tread.

7. A method for improving the handling behavior and the properties in the tradeoff between rolling resistance versus wet grip of vehicle tires comprising preparing the sulfur-crosslinkable rubber mixture as claimed in claim 1.
